(19) United States
(12) Patent Application Publication
(10) Pub. No.: US 2016/0005313 A1
(43) Pub. Date: Jan. 7, 2016

(54) METHOD AND APPARATUS FOR SMART STOP SIGN

(71) Applicant: SAMEER CHOLAYIL, FORT WORTH, TX (US)

(72) Inventor: SAMEER CHOLAYIL, FORT WORTH, TX (US)

(73) Assignee: PERFECT SQUARES INC., EULESS, TX (US)

(21) Appl. No.: 14/752,835

(22) Filed: Jun. 27, 2015

Related U.S. Application Data
(60) Provisional application No. 62/019,427, filed on Jul. 1, 2014.

(51) Int. Cl. G08G 1/095

(52) U.S. Cl. CPC G08G 1/095

(57) ABSTRACT

The invention is an augmented stop sign that functions more like a traffic signal light commonly used on road junctions in place of existing passive stop signs. The cost of the stop sign is extremely less than a typical existing traffic signal system at a junction and the time and effort involved in installation and maintenance is similar to that of installing an existing stop sign.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The invention presented here relates to the traffic stop signs that are common on the roads of US, Canada and other countries.

### BACKGROUND OF THE INVENTION

Existing stop signs on the roads are very passive. The driver has to actively look for the sign or miss it. This is a bigger issue on unfamiliar roads. Traffic signals are much better, but are costly to install and maintain, time consuming and difficult to set up timing. Stop signs also have the problem that they do not adjust well to the traffic load on the road at all. Drivers at stop sign are often not very sure who came first and causes delays, confusion and accidents. Many traffic departments are looking to better the stop sign and make it more visible.

### BRIEF SUMMARY OF THE INVENTION

The present invention tries to make stop signs smarter by adding processor and sensors that are getting cheaper by the day. Sensors like cameras, laser, ultrasound, radar and load cells are added to the stop signs to augment its capabilities. Audio and visual attention seekers create an even better warning system. The system also provides for better visibility under low light and rainy conditions.

The system can also handle traffic much better, allowing 2 or 3 cars per direction depending on traffic load, or learn traffic patterns. The system can also be wired or wireless networked to existing traffic signal management systems. The system can generate tracking of Amber alert vehicles and other vehicles on warrant. The system can be deployed on the current traffic roads, rail roads and traffic junctions to wisely guide vehicles and pedestrians. It can be integrated in smart roads to communicate and support autonomous cars that ensures traffics are controlled smoothly, efficiently and efficaciously. The system can also be implemented in the factories or warehouses to avoid collision between forklifts or vehicles where they are busy.

### BRIEF DESCRIPTION OF THE SEVERAL VIEWS OF THE DRAWING

FIG. 1 is a pictorial representation of one of the simplest preferred embodiment of the present invention. The use of smart stop sign can be in 1, 2 or any number of signs depending on the requirements at the particular road junction or anywhere a stop sign is used, including inside buildings and facilities.

FIG. 1 shows a pair of smart stop signs at a 2-way junction on the road. 100 and 200 are the stop lines at the left and right sides of the junction. 105, 205 are the signposts placed on the left and right sides of the junction. 110 and 210 shows the wireless antennas of the smart signposts on the left and right sides of the junction to form network between the sensors. This could also be used to connect to a cell tower or wide area networks (WANs). 115, and 215 are solar panels to charge the battery pack. The solar panels also act as the shades for the lights of the signposts. 120, and 220 are the sound horns of the signposts on left and right sides of the junction. 125 is the sensor package attached on the left signpost that looks for vehicles or objects in front of the stop sign on the road. The sensor package 225 attached on the right signpost has similar function. Additionally, each signpost has sensor package that looks at the stop lines 100 and 200, which are 130 and 230, corresponding to the left and right signposts. The 230 also has green and red LED's in them that only the driver can see to his right, assuming left side driver positioning in vehicle as seen in most countries. 235 is additional warning LED set on the backside of the sign on the right. It has red, green and yellow LED's in the set. The sign corresponding to 235 on the left signpost is not visible in FIG. 1 but labeled 135. The combined battery and CPU packs of the left and right signposts are indicated as 140, and 240. The computer board of the system is attached to the battery pack. 245 is an optional sensor package on the back of the sign to detect traffic stuck in the junction. Such sensor is not visible in the drawing for the stop sign on the left labeled 145. 145 and 245 are more useful in 4-way or more way junctions to ensure the intersection is clear before issuing further LED signals. 150 is a representation car in the valid stop zone on the left side of the junction. 250 is a representation of a bicycle on the right side of the road not in the valid stop zone yet. 155 is the top and bottom main LED color sign on the left side of the junction. The corresponding sign labeled 255 on the other side is not visible in the FIG. 1.

FIG. 2A shows the front side and 2B shows the backside of another embodiment of the invention. This package can be removably mounted on an existing stop sign to turn it into a smart stop sign. 300 is a solar panel to charge the system battery. In other embodiments, the solar panel and solar charger systems may be eliminated if wired power supply is available and easy to access. 400 is the multiple cameras and indicator used by the system. 500 is the tamper and weatherproof enclosure that contains the battery and electronic control boards. 600 is the green LED array. 700 is the yellow LED array. 800 is red LED array.

FIG. 3 shows the use of a smart signs networked for use in a 4-way junction. 1000, 1100, 1200 and 1300 are the individual smart signposts.

### DETAILED DESCRIPTION OF THE INVENTION

The sensor packages of the invention 130,230, 125, 225 and 245, 145 may include camera along with computer vision running on CPU's in 140, 240 acting as vehicle location, speed, deceleration and stoppage detection. Cheap cameras and powerful single board computers like Raspberry Pi under 30 dollars at today's price levels make this a cheap system. The sensor package may also include sensors for under road and wired magnetic/load cell, IR, ultrasound, laser or simple radars for almost all of the duties of the camera and CPU except for object type detection. Any combination of the above sensors is also suitable. The sensor packages only uses known methods for the detections. Practitioner of the art will appreciate that current full traffic signal system only uses costly magnetic and load cells for vehicle detection and signal logic determination. Such systems can only sense if a metallic object or heavy load is over it or not. Such sensors also make digging the road necessary to install the magnetic or load cells. They also rely on timing to give green signal in turns.

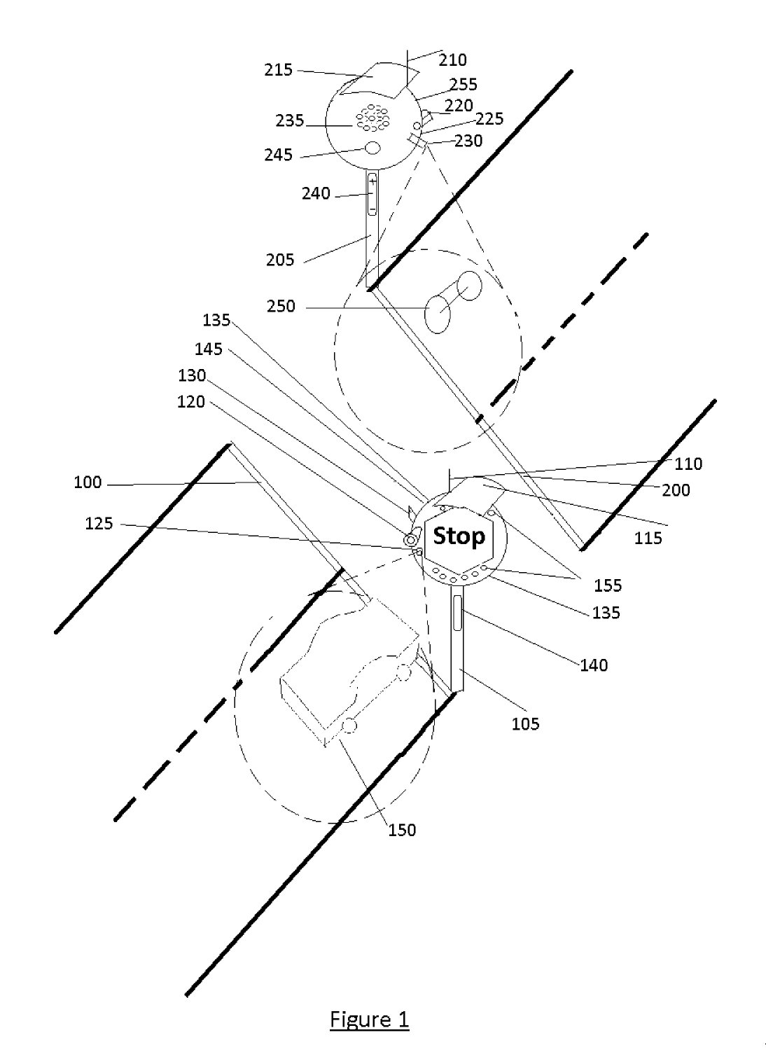

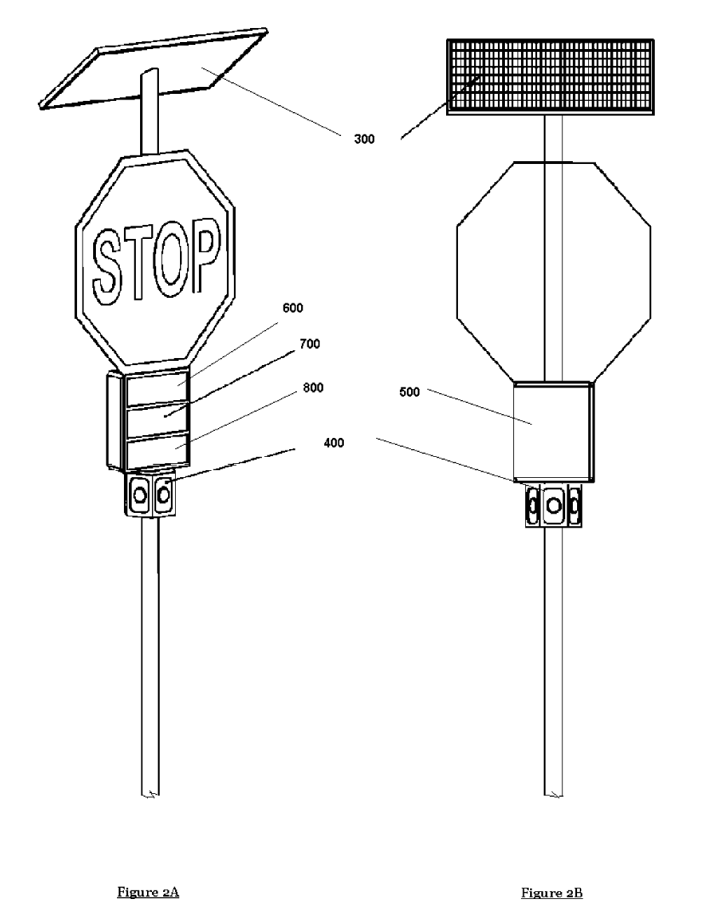

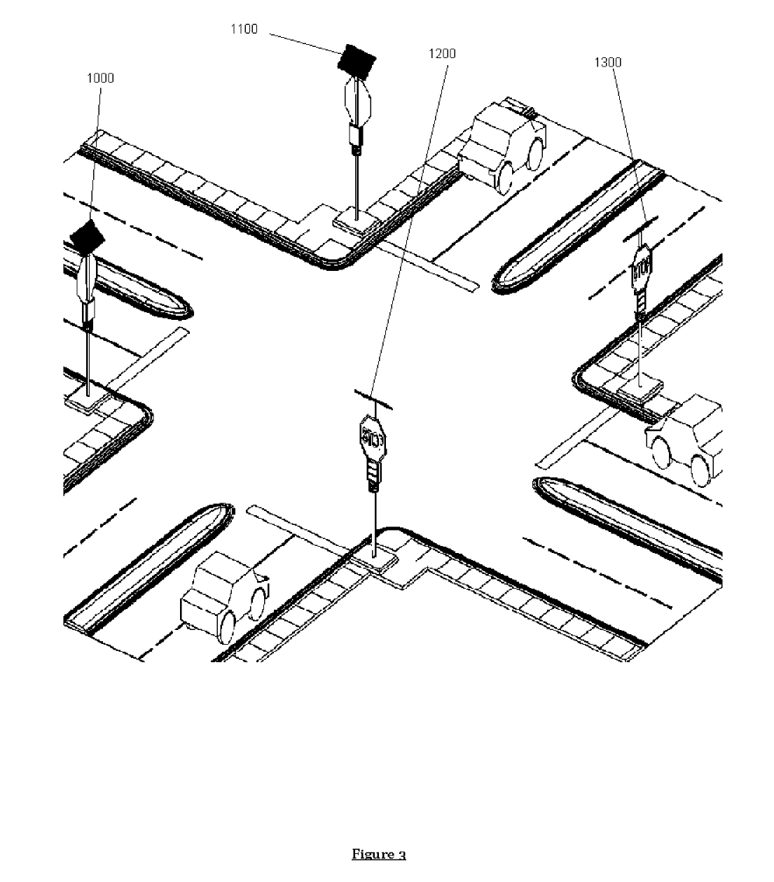

The basic job of the sensor package 125, 245 is to detect a vehicle approaching, stopped or leaving the stop zone determined by the stop lines at 100, 200. Sensor packages 130, 230 detect the vehicle position with respect to the stop lines 100, 200. Consider the situation of FIG. 1 is that the vehicle 150 is stopped at the stop sign of signpost 105. The red/green LED of the sensor package 130 guides the driver 150 to make a valid stop in the stop zone. This prevents the driver waiting for signal endlessly when he not fully in the valid stop zone. A vehicle 250 is coming in at the opposite side of the junction near stop sign 205. This vehicle is not stopped yet fully. Under the initial condition, the light colors at 155, 255 are red. The CPU in 140 of the left signpost detects valid stop of 150 and communicates with CPU in 240 of the right signpost through the wireless network. The communication is bi-directional to ensure that both signposts work accordantly. For example, if the vehicle 150 reaches the stop line 100 and stops first, the CPU in 140 will turn on the green LED signals of 155 and 235. If the driver of the vehicle 250 stop in the valid stop zone of stop line 200 before the next driver comes to line, he will get the next green LED signals on 255 and 135. The stop condition validity of the vehicle 150 and/or 250 will be displayed on LEDs in 230. If the two CPUs in 140 and 240 could not arrive at a decision, they both instruct the signals to flash LED lights 155, 255, 135 and 235 yellow so that the drivers can continue to use the stop signs as regular stop signs in case of rare failures in the system.

System of FIG. 1 considers a 2-way junction. The same system can handle multi-way or single way stop signs.

More complex operations are possible for this type of smart stop signs. The CPU's in 140, 240 can study traffic pattern and load and also allow 2 vehicles at a time on one path to reduce traffic congestion.

The embodiment does not need to be attached to stop sign. In such case, it can operate as a regular traffic signal if applicable. The location of the stop sign can be moved to mid point of the road stop line or even mounted like a regular traffic signal light without installation and maintenance difficulties as discussed earlier.

The invention claimed is:

1. A method and apparatus for an automated stop sign comprising:
i. a battery pack with solar charger;
ii. a computing device embedded with controllable and programmable software;
iii. multi-color LED array on the front with shade;
iv. multi-color LED array on the back with shade;
v. a front camera that looks at the road to detect any vehicle approaching said stop sign;
vi. a side camera that looks at the stop line, sideways to detect any vehicle in stop zone;
vii. a back side camera to look at the traffic junction behind said stop sign;
viii. a radio frequency wireless transceiver and antenna for wireless communication;
ix. a connector for connecting a plurality of different wired sensors and wired network;
x. an audible horn;
xi. a post holding said stop sign that houses the said apparatus.

2. The system of claim 1, wherein:
i. a combination of said multiple cameras capturing all directions at said traffic junction compromising: said front camera detects vehicles on the road in the front of said stop sign; said side camera monitors presence of vehicles within valid stop zone; and said back camera is added in a multi-way traffic junction and 2-way stop sign with no stop for through traffic to ensure said traffic junction is clear. Additional cameras will be added-in to have full view of said traffic junction. Built-in image processing algorithms of said computing device detects presence, speed and dimension of vehicles, and estimates arrival time of each said vehicle;
ii. Said sensors attached to said connector are also used to detect presence, speed of said vehicles, and estimates arrival time of each said vehicle;
iii. Said computing device recognizes any vehicles that are not decelerating at said traffic junction and produces a warning sound using said horn of said apparatus;
iv. Said computing device trigger a green/red LED signal to guide said vehicles looking to their right to acknowledge a valid stop condition;
v. While said apparatus can operate as a single unit, said computer device searches for other adjacent units at said junction using said radio frequency wireless transceiver to form a wireless network sign posts;
vi. Data collected are shared and compared between said adjacent units and decisions made by said computer devices are indicated by said multi-color LED array;
vii. If a failure of system is detected, yellow flashing lights are presented. All networked stop signs are also instructed to do so.

3. Said apparatus of claim 1 connects to multiple such apparatuses to form a network of signs in a multi-way traffic junction by exchanging among themselves said information about approaching vehicles at each sign and estimated time at which said vehicles will make the stop. Then the collective comes to an agreement on the order to give green signals at each sign.

4. Information exchange of claim 2 is through wireless network connection.

5. Information exchange of claim 2 is through wired network.

6. The system of claim 1, wherein said sensors attached to said connector is a load cell.

7. The system of claim 1, wherein said sensors attached to said connector is a metal vehicle chassis detector.

8. The system of claim 1, wherein said sensors attached to said connector is a laser object and distance meter.

9. The system of claim 1, wherein said sensors attached to said connector is an IR object and distance meter.

10. The system of claim 1, wherein said sensors attached to said connector is an ultrasound object and distance meter.

11. The system of claim 1, wherein said sensors attached to said connector is a radar object and distance meter.

12. The system of claim 1, wherein said sensors attached to said connector is any combination of sensors of claims 6 to 11.

13. The system of claim 1, wherein said sensors attached to said connector directly transfer measurement information to said computer devices using wired or wireless communication.

14. The system of claim 1, wherein said apparatus could uses only sensors instead of said cameras to save power.

15. The system of claim 1, wherein the sensors may be physically separated and at a distance from the said apparatus.

16. The system of claim 1, wherein said shades act as solar panels.

17. The system of claim 1, wherein said apparatus and method works without a stop sign, but like a regular traffic signal when system is mounted as traffic signal and software logic updated.

18. The system of claim 1 wherein said apparatus are deployed in a big warehouse or factory which traffic is busy.

19. Said apparatus and methods of claims 1 and 2 are used for pedestrian signal.

20. Said radio frequency transceiver of claims 1 and 2 is capable of connecting to cellular networks and wide area networks (WAN) to form an Internet-of-Things traffic networks.

21. The system of claim 1 sends traffic data and said agreement information of claim 3 are sent to autonomous vehicles to allow warning and control flow of autonomous vehicles through the junction using systems of claim 1.

22. The system of claim 1, wherein said cameras and computing device may record the traffic video to review traffic accidents at stop signs where approved by law.

23. The system of claim 1, wherein said cameras may be used to detect amber alert vehicles where approved by law.
